(19) United States
(12) Patent Application Publication
(10) Pub. No.: US 2009/0281657 A1
(43) Pub. Date: Nov. 12, 2009

(54) Automatic medication reminder and dispensing device, system , and method therefor

(75) Inventors: Alexander Gak, Fort Lee, NJ (US); Mirek Bogdanowicz Msee, Hillsborough, NJ (US)

Correspondence Address: DINESH AGARWAL, P.C., 5350 SHAWNEE ROAD, SUITE 330, ALEXANDRIA, VA, 22312, US

(73) Assignee: BAETA Corp., Fort Lee, NJ (US)

(21) Appl. No.: 12/453,255

(22) Filed: May 5, 2009

Related U.S. Application Data
(60) Provisional application No. 61/071,587, filed on May 7, 2008.

(51) Int. Cl. G06F 17/00; B65D 83/04

(52) U.S. Cl. 700/242; 221/3; 221/1

(57) ABSTRACT

A medication reminder and dispensing system includes a computing or electronic device for programming a medication regimen, such as a prescription, a docking station or unit for downloading the medication regimen and storing a medication, a personal medicine container for holding a daily or weekly supply of the medication and receiving the medication regimen. The personal medicine container is carried by a user and includes an alarm for reminding the user to take or administer the medicine in accordance with the medication regimen.

### CROSS-REFERENCE TO RELATED APPLICATIONS

The present application claims the benefit of prior U.S. Provisional Application Ser. No. 61/071,587, filed May 7, 2008, which is hereby incorporated herein in its entirety by reference.

### FIELD AND BACKGROUND OF THE INVENTION

The present invention is generally directed to a health care-related device, and more particularly to an automatic medication reminder and dispensing device, system and method therefor.

Thousands of prescriptions are written and various medications are dispensed daily in the health care industry in the U.S. and throughout the world. These prescriptions are for patients of all ages, including small children to the elderly. While some prescriptions are for a single medication to be taken over a short period of time, many other prescriptions include administration or taking of several medications over a short or long period of time. Regardless of whether a single medication or multiple medications, and the regimen, patients often do not take the medication as prescribed. The reasons are many, including ready inaccessibility to the medication, forgetfulness, preoccupation with other matters in life, attending to multiple tasks at a given time, short or long term memory disorders, and various other medical or non-medical reasons. It goes without saying that proper dosage administration and following of the prescribed regimen is not only important but can be critical in many situations. Improper or incomplete administration can lead to prolongation of the disorder or illness, or incomplete or poor recovery. It might even be fatal in some situations.

Various devices and systems are available in prior art. Examples include U.S. Pat. Nos. 7,317,803 B1; 7,302,311 B2; 7,269,476 B2; 7,213,721 B2; 7,158,011 B2; 7,100,793 B2; 7,048,141 B2; 7,044,302 B2; 7,042,807 B1; 6,988,634 B2; 6,771,174 B2; 6,732,884 B2; 6,702,146 B2; 6,690,998 B1; 6,662,081 B1; 6,622,887 B1; 6,607,094 B2; 6,594,549 B2; 6,574,165 B2; 6,401,991 B1; 6,263,259 B1; 6,234,343 B1; 6,169,707 B1; 6,021,918; 6,004,020; 5,979,702; 5,915,589; 5,810,198; 5,752,621; 5,646,912; 5,609,268; 5,472,113; 5,408,443; 5,405,048; 5,289,157; 5,219,093; 5,110,008; 5,097,982; 4,962,491; 4,915,256; 4,911,327; 4,785,932; 4,638,923; Des. 393,203; 2007/0271001 A1; 2007/0257051 A1; 2007/0170199 A1; 2007/0156282 A1; 2007/0093935 A1; 2007/0093932 A; 2007/0012712 A1; 2006/0259188 A1; 2006/0259187 A1; 2006/0201961 A1; 2006/0163267 A1; 2006/0124655 A1; 2005/0258066 A1; 2004/0182873 A1; 2003/0222090 A1; and 2002/0047019 A1.

### BRIEF SUMMARY AND ASPECTS OF THE INVENTION

The present summary and aspects are provided to illustrate a few non-limiting, non-restrictive concepts that are further shown or described below in the drawings and the detailed description. The noted concepts are not limited to the main features of the claimed subject matter, nor are intended to be used as an aid in determining the scope of the claimed subject matter.

The present invention is generally directed to a device, system, and/or method for reminding and dispensing one or more medications to be taken by a subject.

The present invention is further generally directed to a device, system, and/or method for reminding and dispensing one or more medications, which is programmable and functions automatically.

The present invention is further directed to a device, system, and/or method, which assists a subject in following a proper medication regimen as prescribed by a health care practitioner.

The present invention is further directed to a device, system, and/or method for reminding and dispensing one or more medications for a subject, which makes it easy and convenient for the subject to carry all the necessary medications for a given period of time, for example, daily, weekly, etc., in one portable container.

The present invention is further directed to a device, system, and/or method for reminding and dispensing one or more medications for a subject, wherein all the prescribed medications are stored and managed from a central docking station or unit.

The present invention is further directed to a device, system, and/or method for reminding and dispensing one or more medications for a subject, wherein a central docking station or unit discharges the necessary medication into a portable personal medicine container, on-demand.

The present invention is further directed to a device, system, and/or method for reminding and dispensing one or more medications for a subject, which is compatible with the Internet, computers and specifically personal computers, and various other portable or hand-held mobile or wireless devices, such as cell phones, laptops, personal notepads and organizers, a Blackberry®, a Treo®, and similar devices, presently known or later developed.

One aspect of the present invention includes a personal medication reminder and dispensing device, which includes a programmable docking unit with at least one chamber for storing bulk medication and a base including a slot for dispensing a medication on-demand, and a programmable personal medicine container insertable through the slot for receiving a predetermined supply of the medication and for downloading a medication regimen from the docking unit. The personal medicine container includes a medication holding section and a display section, and an alarm for reminding a person to take or administer the medicine in accordance with the medication regimen.

Another aspect of the present invention includes a personal medication reminder and dispensing device, which includes a programmable docking unit with a plurality of chambers for storing bulk medication and a base including a slot for dispensing one or more medications on-demand, and a programmable personal medicine container insertable through the slot for receiving a predetermined supply of the medication and for downloading a medication regimen from the docking unit. The personal medicine container includes a medication holding section and a display section, wherein the holding section includes a plurality of pockets corresponding in number to the chambers. A movable cover provides access to the pockets. The personal medicine container includes an alarm for reminding a person to take or administer the medicine in accordance with the medication regimen.

Another aspect of the present invention includes a medication reminder and dispensing system, which includes a computing or electronic device for programming a medication regimen, and a personal medication reminder and dispensing device. The device includes i) a programmable docking unit with at least one chamber for storing bulk medication and a base including a slot for dispensing a medication on-demand, and ii) a programmable personal medicine container insertable through the slot for receiving a predetermined supply of the medication and downloading a medication regimen from the docking unit. The personal medicine container includes a medication holding section and a display section, and an alarm for reminding a person to take or administer the medicine in accordance with the medication regimen.

Another aspect of the present invention includes a medication reminder and dispensing method, which includes a) providing a medication regimen, b) providing a personal medication reminder and dispensing device that includes i) a programmable docking unit with at least one chamber for storing bulk medication and a base including a slot for dispensing a medication on-demand, and ii) a programmable personal medicine container insertable through the slot for receiving a predetermined supply of the medication and for downloading a medication regimen from the docking unit, wherein the personal medicine container includes a medication holding section and a display section, and an alarm for reminding a person to take or administer the medicine in accordance with the medication regimen, c) downloading the medication regimen into the docking unit, d) obtaining the predetermined supply of the medication into the personal medicine container from the docking unit, and e) taking or administering the medicine from the personal medicine container when prompted by the alarm.

Another aspect of the present invention includes a medication reminder and dispensing method, which includes a) providing a medication regimen, b) providing a personal medication reminder and dispensing device that includes i) a programmable docking unit with a plurality of chambers for storing bulk medication and a base including a slot for dispensing one or more medications on-demand, ii) a programmable personal medicine container insertable through the slot for receiving a predetermined supply of the medication and for downloading a medication regimen from the docking unit, iii) wherein the personal medicine container includes a medication holding section and a display section, iv) wherein the holding section includes a plurality of pockets corresponding in number to the chambers, and a movable cover provides access to the pockets, and vi) wherein the personal medicine container includes an alarm for reminding a person to take or administer the medicine in accordance with the medication regimen, c) downloading the medication regimen into the docking unit, d) obtaining the predetermined supply of the medication into the personal medicine container from the docking unit, and e) taking or administering the medicine from the personal medicine container when prompted by the alarm.

In summary, the present invention is directed to a device, system, and/or method for reminding and dispensing one or more medications for a subject, which assists the subject in following the prescribed regimen in a timely and proper manner, thereby enhancing compliance.

### BRIEF DESCRIPTION OF THE DRAWINGS

One of the above and other concepts, aspects, objects, novel features and advantages of the present invention will become apparent from the following detailed description of the preferred embodiment(s) invention, as illustrated in the drawings, in which:

FIG. 1 is a front perspective view of a medication reminder and dispensing device, in accordance with a preferred embodiment of the present invention;

FIG. 2 is an enlarged schematic, cross-sectional view of one of the five illustrated medicine chambers of the device of FIG. 1, shown without the lid;

FIG. 3 is an exploded, elevational view of the medicine chamber shown in FIG. 2;

FIG. 4 is a top plan view of the medicine chamber shown in FIG. 3;

FIG. 5 is an enlarged top plan view of the personal medicine container (PMC) shown in FIG. 1;

FIG. 6 illustrates an alternative embodiment of the docking unit, partly broken to show internal details;

FIG. 7 is a schematic illustration of a medication reminder and dispensing system, in accordance with a preferred embodiment of the present invention; and

FIGS. 8A-8B illustrate a flowchart of a medication reminder and dispensing sequence, in accordance with a preferred method of the present invention.

### DETAILED DESCRIPTION OF THE PREFERRED EMBODIMENT(S) OF THE INVENTION

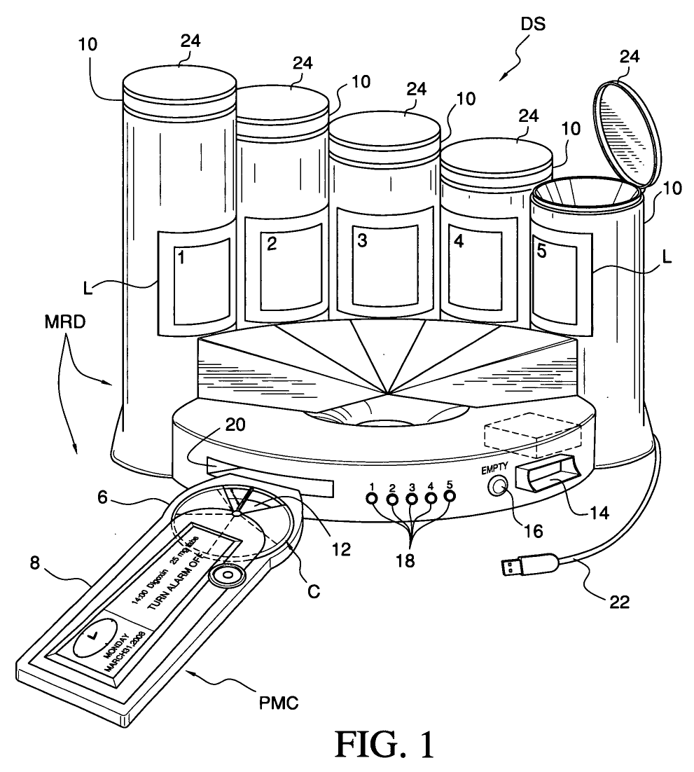

Referring to FIG. 1, a preferred embodiment of the medication reminder and dispensing device MRD of the present invention will now be described. As shown, the device MRD includes a docking station DS and a compatible personal medicine container PMC with a medication holding section 6 and a display section 8. Although the docking station DS is preferably portable, it functions as and is used to store bulk medication, and to refill the personal medicine container PMC, which is carried by a person to take or administer the medications daily, weekly, etc. The medications include prescription, as well as non-prescription and over-the-counter (OTC) drugs, herbal and dietary supplements, and vitamins, etc., as capsules, tablets, pills, or in any other form.

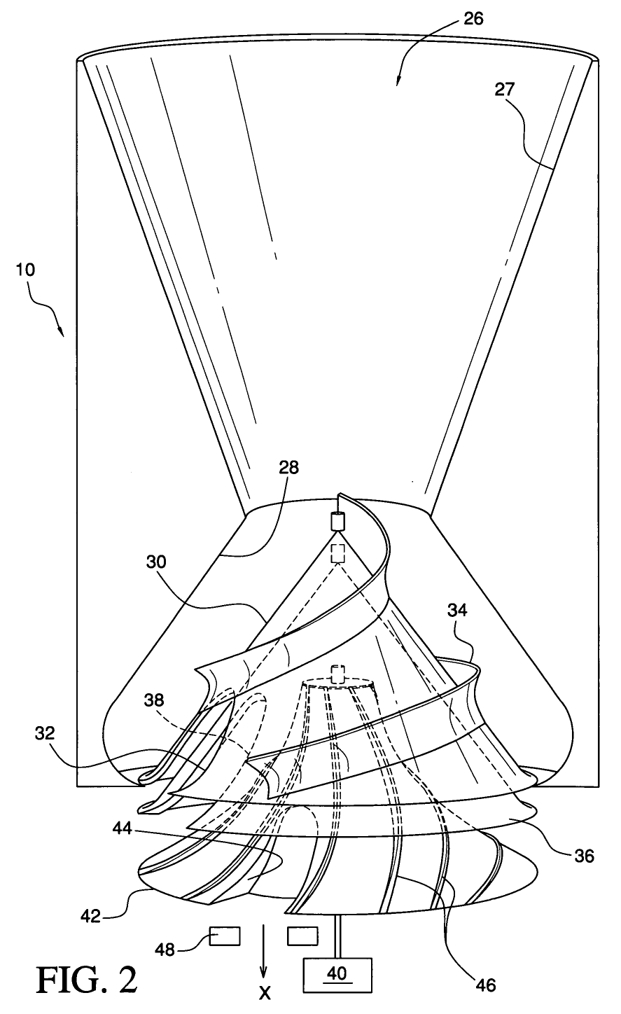

The docking station DS includes, preferably five medicine storage chambers 10 of varying height or dimensions to accommodate different size medicines. However, the internal structure and configuration of each storage chamber 10 is substantially the same as shown in FIG. 2, and described below in more detail. (It is noted herewith that the number, dimensions, overall configuration and arrangement of the storage chambers 10 can be varied, as desired.)

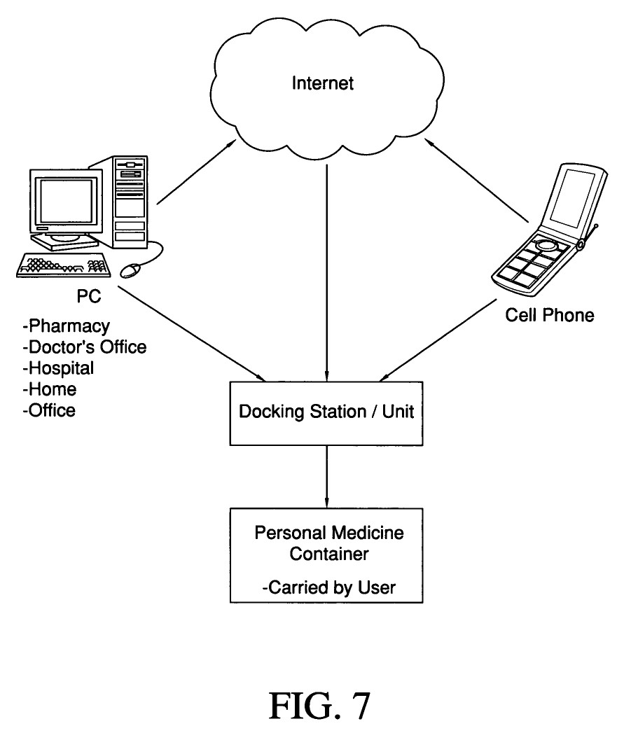

The storage chambers 10 are used to fill and store various bulk medications to be discharged into the personal medicine container PMC, on a fixed interval basis, such as daily, weekly, etc. To that end, the docking station DS includes an internal mechanism (one embodiment shown in FIG. 6) that when prompted by the personal medicine container PMC, discharges the appropriate medicine into a rotatable carousel C in the medication holding section 6, which includes pockets 12, preferably corresponding in number to the medicine storage chambers 10. Alternatively, the internal mechanism will empty or discharge medicine from the medicine storage chambers 10, through a window 14, when the “Empty” button 16 is activated.

Prior to activating the button 16, the user would select an appropriate medicine storage chamber 10 to empty. To that end, five buttons 18 (numbered 1 through 5), corresponding to the five storage chambers 10, are provided on the front of the docking station DS. Accordingly, by first activating the appropriately numbered button 18, and then activating the button 16, the respective medicine storage chamber 10 can be easily emptied. (It is noted herewith that this sequence can be reversed, if desired.)

Each chamber 10 is provided with a suitable front label L, for the convenience of the user to provide information relevant to the medicine being stored therein.

The docking station DS includes a slot 20 for receiving the personal medicine container PMC for programming and filling of the carousel C. A USB cable 22 (or other compatible cable/connection) is provided to connect the docking station DS to a computer or other device to download appropriate dosage and administration information, as described below in more detail.

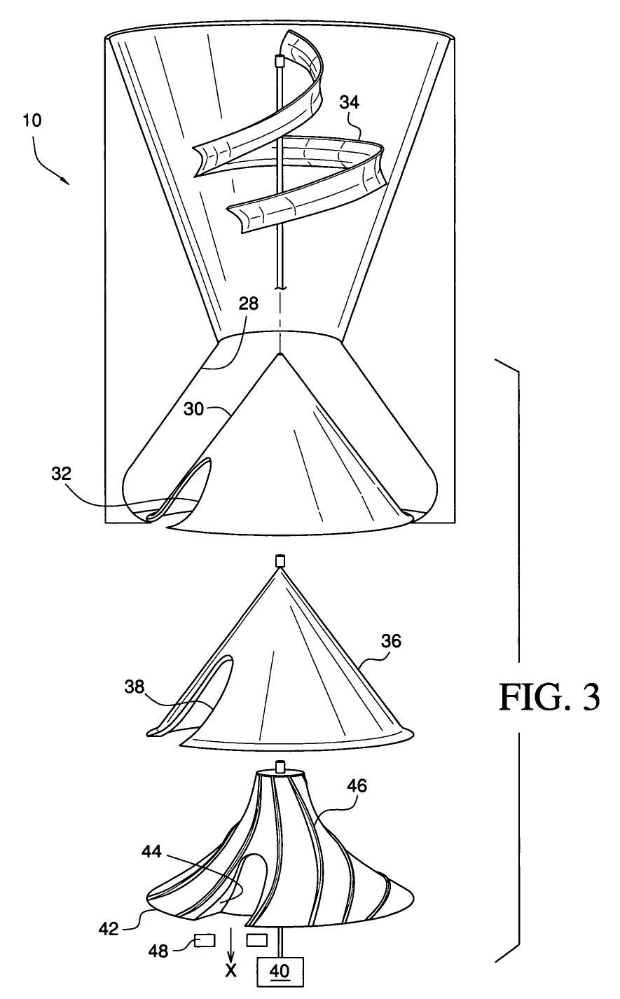

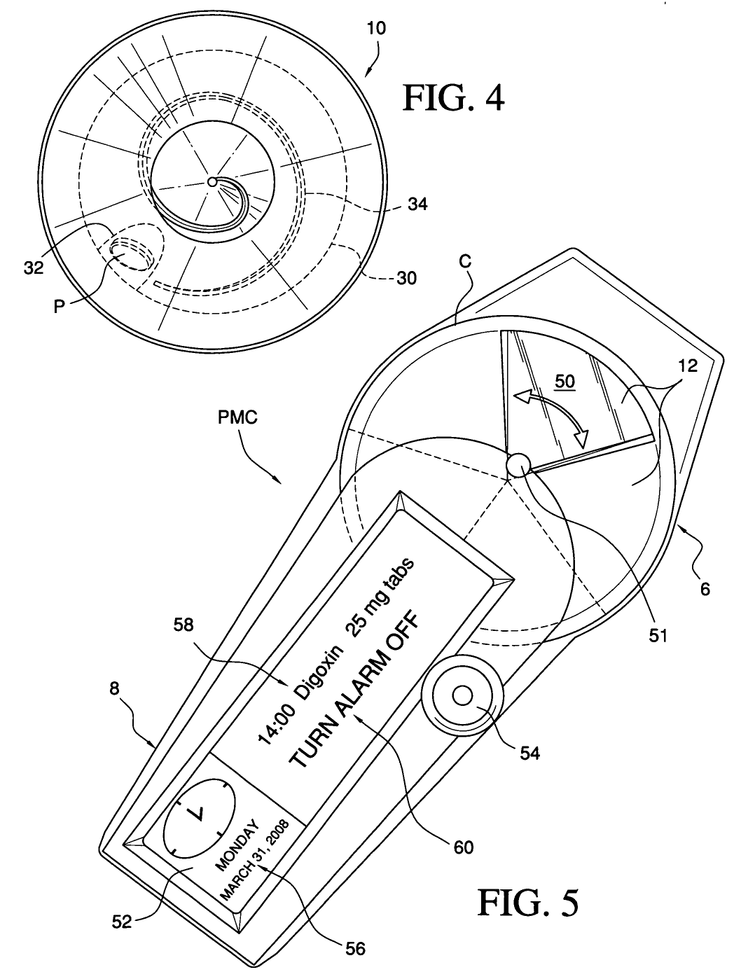

Referring to FIGS. 2-4, the mechanical details of a medicine storage chamber (or pill container) will now be described. Each medicine storage chamber 10 includes a flippable or removable lid 24 (FIG. 1) for covering the internal pill container recess 26. Preferably, the upper section 27 of the recess 26 is funnel-shaped (downwardly radially inwardly extending) to direct the flow of the medication towards the lower, radially outwardly extending section 28, by gravity. A preferably conical outer cone 30, with a pill slot 32, is fixedly mounted in the base section 28 (FIGS. 3-4). A spiral rim or guide 34 slides over the outer cone 30 in a circular fashion to direct, for example, a pill P (FIG. 4) towards the slot 32.

A second inner cone 36, with a slightly larger pill slot 38 than the pill slot 32, is concentric with the outer cone 30 and is rotatable relative thereto by an electric motor 40. An innermost cone 42, with a pill slot 44, is concentric with the outer cone 30 and the inner cone 36.

One or more downwardly directed radial guides or slides 46 fan over the innermost cone 42, to direct the pill P into the slot 44 to be discharged past an optical sensor 48 (see arrows X in FIGS. 2-3). As can be readily observed from FIG. 2, the bottom diameter of the innermost cone 42 is larger than the bottom diameter of each of the outer cone 30 and inner cone 36, to facilitate the path of the pill P through the slots 32, 38 and 44, and out of the bottom perimeter of the medicine storage chamber 10.

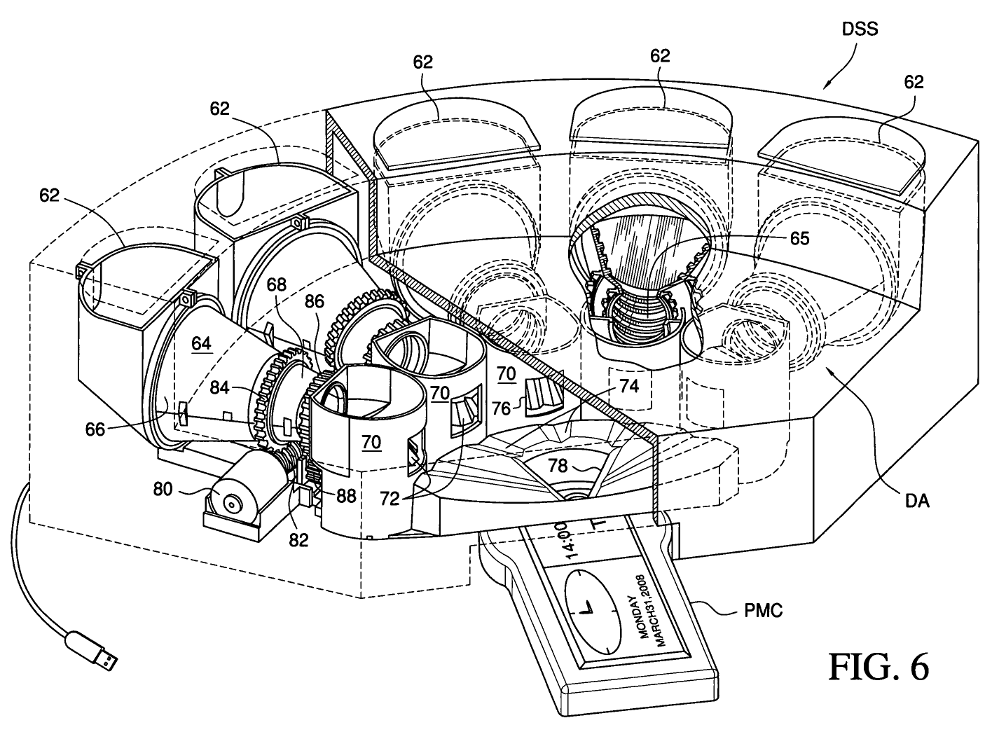

As noted above, the personal medicine container PMC includes a carousel C with pockets 12, corresponding in number to the storage chambers 10. As best shown in FIG. 5, a preferably laterally slidable cover 50, anchored at 51, allows access to the underlying pocket 12. In the display section 8, the personal medicine container PMC includes a screen 52 for displaying various information, and a button 54 for deactivating the alarm (described below in more detail) or for other various functions. The screen 52 displays information, such as day, date, time of the day (collectively designated by numeral 56), the name of the medicine and dosage information 58, and an alarm command 60. (It is noted herewith that foregoing is a mere illustration of various information that can be displayed via screen 52, and it is within the scope of the present invention to display other information, as desired or necessary.)

FIG. 6 discloses another preferred embodiment of the docking station DSS, which includes individual internal discharge assemblies DA for conveying the medicine from, preferably five storage chambers 62 to the personal medicine container PMC, on-demand. The overall configuration and function of the chambers 62 are the same as the chambers 10. (As noted above, the number, dimensions, overall configuration and arrangement of the storage chambers 62 can be varied, as desired.)

Each discharge assembly DA is preferably associated with one chamber 62, and includes a generally cone-shaped drum 64, the larger end 66 of which is in fluid communication with the inside of the chamber 62, and the narrower end 68 thereof opens into a housing 70. The internal periphery of the drum 64 is provided with a spiral ridge 65 to facilitate moving of the medicine. A generally disc-shaped rotatable conveyor 72 is positioned inside the housing 70 for receiving the medicine from the drum 64 and pouring it out onto a chute 74 through a window 76. The medicine slides down the chute 74 into a central yoke 78, which is in alignment with the individual pockets 12 in the carousel C of the personal medicine container PMC.

A motor 80 with an output worm-gear 82, selectively engages a circular gear 84 on the external periphery of the drum 64 of a particular discharge assembly DA. In other words, it is preferred that a single motor selectively rotate the drum of one discharge assembly DA, at one time. It is noted, however, that individual motors may be provided for each discharge assembly DA, to separately rotate the drums 64.

A second circular gear 86 on the drum 64 is in engagement with a housing gear 88 for rotating the conveyor 72.

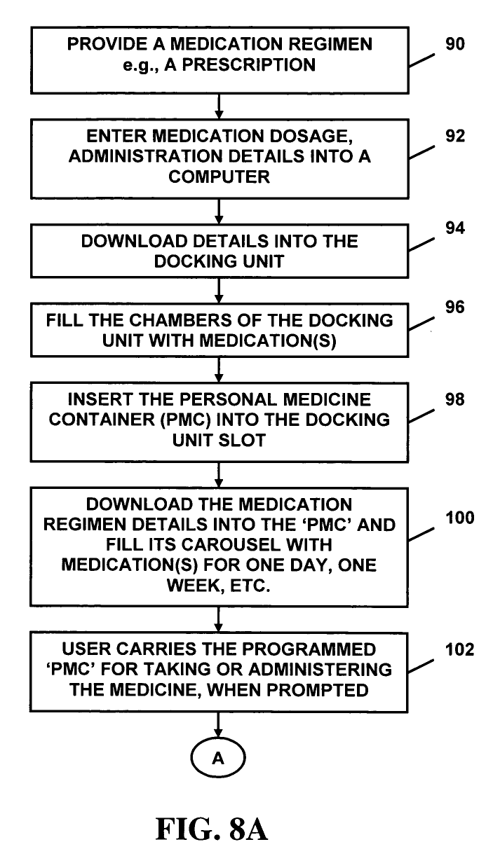

FIG. 7 illustrates a preferred embodiment of the overall personal medication reminder and dispensing system of the invention. As shown, the docking station or unit DS is in a wired or wireless communication with a personal computer, the Internet, or a mobile device, such as a cell phone. The personal computer can be located at a pharmacy, doctor's office, hospital, or at home or office of a user. As described above, the personal medicine container PMC downloads the medication regimen from the docking station DS.

### Use and Operation

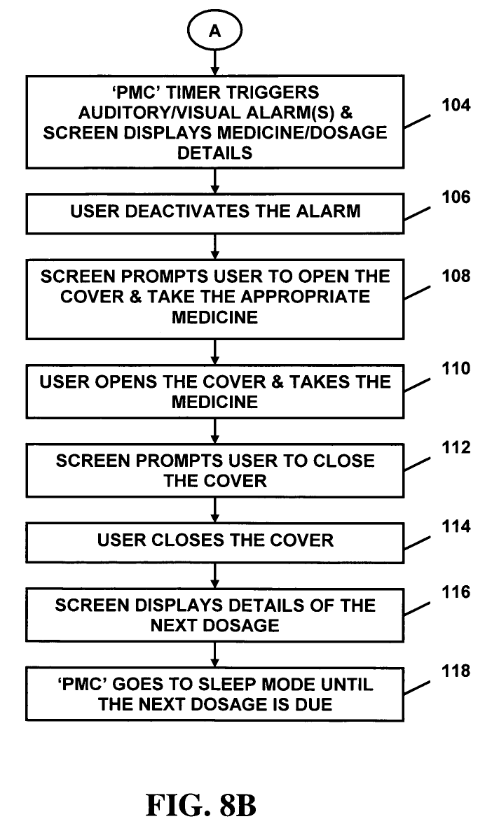

Referring to FIGS. 7 and 8A, in order to use and operate the medicine reminder and dispensing device MRD of the present invention, the dosage and administration information 90 for one or more medications would be entered by a patient, user, or a health-care professional, into a computer or other device, such as a laptop, cell phone, etc. (step 92), which may be connected to a network, an intranet, or the Internet. This information can then be downloaded into a suitable logic or microprocessor unit (CPU) of the medicine reminder and dispensing device MRD of the present invention (step 94) via the USB cable 22 (or other suitable connection/wireless means).

Once the downloading is complete (or before, if desired), the corresponding medications would then be emptied into the respective medicine storage chambers 10 (or 62) (step 96). The personal medicine container PMC would then be inserted into the device MRD through the slot 20 (step 98), to download the entire medication regimen thereon and to fill the pockets 12 of carousel C (step 100). In other words, once the personal medicine container PMC is inserted into the slot 20, the docking station DS (or DSS) would not only program the personal medicine container PMC with the entire medication regimen, it would also automatically fill the pockets 12 with the appropriate medicine, to be taken by the user, preferably in one day. Once this is done, the user would then carry the personal medicine container PMC with him/her (step 102) until reminded to return to the docking station DS (or DSS) for refilling purposes.

Referring now to FIGS. 5 and 8B, a reminding and dispensing sequence is briefly described. As noted above, the personal medicine container PMC would have a built-in clock. Therefore, in accordance with the information downloaded from the docking station DS (or DSS), an internal timer would trigger, preferably an auditory and visual alarm and display the name of the medicine and dosage information 58 (step 104). Upon deactivation of the alarm (step 106), a new message would be displayed asking the user to “Open Cover and Take One Pill” (step 108). When the user has opened the cover 50 (step 110), a new message “Close the Cover” would be displayed (step 112). When the cover 50 is closed (step 114), the screen 52 would indicate the next dosage information (step 116). The personal medicine container PMC would then assume a sleep mode until the next dosage is due (step 118). (It is noted that the foregoing are non-restrictive examples of various messages/commands, which can be varied, revised or supplemented.)

From the above, it can be readily observed that the medicine reminder and dispensing device of the present invention is user-friendly and can be effectively used to follow a prescribed regimen in a timely and proper manner to enhance compliance, and thus the overall well-being of a subject.

While this invention has been described as having preferred sequences, ranges, steps, materials, structures, features, components, or designs, it is understood that it is capable of further modifications, variations, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

What is claimed is:

1. A personal medication reminder and dispensing device, comprising:
a) a programmable docking unit comprising at least one chamber for storing bulk medication and a base including a slot for dispensing a medication on-demand;
b) a programmable personal medicine container insertable through said slot for receiving a predetermined supply of the medication and for downloading a medication regimen from said docking unit;
c) said personal medicine container including a medication holding section and a display section; and
d) said personal medicine container including an alarm for reminding a person to take or administer the medicine in accordance with the medication regimen.

2. The device of claim 1, wherein:
a) a plurality of said chambers are connected to said base and are in individual communication with said slot for dispensing the medication.

3. The device of claim 2, wherein:
a) said medication holding section of said personal medicine container comprises pockets corresponding in number to said chambers.

4. The device of claim 3, wherein:
a) said pockets are arranged radially in a rotatable carousel.

5. The device of claim 4, further comprising:
a) a movable cover for providing access to the pockets.

6. The device of claim 1, wherein:
a) said chamber comprises an internal recess including an upper radially inwardly extending section and a lower radially outwardly extending section; and
b) a generally conically-shaped first member fixed mounted in said lower section of said recess.

7. The device of claim 6, further comprising:
a) a generally conically-shaped second member rotatably mounted inside said first member; and
b) a generally conically-shaped third member mounted inside said second member.

8. The device of claim 7, wherein:
a) each of said first, second, and third members includes first, second, and third openings, respectively, about the periphery thereof for receiving medication therethrough.

9. The device of claim 8, further comprising:
a) a generally central spiral rim rotatable over the periphery of said first member for directing medication towards the first opening.

10. The device of claim 9, further comprising:
a) a radial guide rotatable over the periphery of said third member for directing medication towards the third opening.

11. The device of claim 10, further comprising:
a) a sensor disposed adjacent the third opening for detecting the presence of medication.

12. The device of claim 1, wherein:
a) the predetermined supply of the medication corresponds to daily, weekly, or monthly supply.

13. The device of claim 1, wherein:
a) said docking unit includes a logic or microprocessor for downloading a medication regimen from a desk-top computer, a portable computer, a hand-held electronic device, a wireless device, a network, an intranet, or the Internet.

14. The device of claim 1, wherein:
a) said chamber comprises an internal recess in communication with said slot by a discharge assembly for dispensing the medication;
b) said discharge assembly, comprises:
i) a generally conically-shaped rotatable drum in communication with the internal recess of said chamber;
ii) a conveyor positioned adjacent said drum; and
iii) a chute for moving medication from said conveyor towards said slot.

15. The device of claim 14, further comprising:
a) a motor and gear mechanism for rotating said drum.

16. The device of claim 14, wherein:
a) a plurality of said chambers are arranged in a circular fashion.

17. A personal medication reminder and dispensing device, comprising:
a) a programmable docking unit comprising a plurality of chambers for storing bulk medication and a base including a slot for dispensing one or more medications on-demand;
b) a programmable personal medicine container insertable through said slot for receiving a predetermined supply of the medication and for downloading a medication regimen from said docking unit;
c) said personal medicine container including a medication holding section and a display section;
d) said holding section including a plurality of pockets corresponding in number to said chambers;
e) a movable cover for providing access to the pockets; and
f) said personal medicine container including an alarm for reminding a person to take or administer the medicine in accordance with the medication regimen.

18. The device of claim 17, wherein:
a) said docking unit includes a logic or microprocessor for downloading a medication regimen from a desk-top computer, a portable computer, a hand-held electronic device, a wireless device, a network, an intranet, or the Internet.

19. A medication reminder and dispensing system, comprising:
a) a computing or electronic device for programming a medication regimen;
b) a personal medication reminder and dispensing device, comprising:
i) a programmable docking unit comprising at least one chamber for storing bulk medication and a base including a slot for dispensing a medication on-demand;
ii) a programmable personal medicine container insertable through said slot for receiving a predetermined supply of the medication and downloading a medication regimen from said docking unit;
iii) said personal medicine container including a medication holding section and a display section; and
iv) said personal medicine container including an alarm for reminding a person to take or administer the medicine in accordance with the medication regimen.

20. The device of claim 1, wherein:
a) said docking unit includes a logic or microprocessor for downloading a medication regimen from a desk-top computer, a portable computer, a hand-held electronic device, a wireless device, a network, an intranet, or the Internet.

21. A medication reminder and dispensing method, comprising the steps of:
a) providing a medication regimen;
b) providing a personal medication reminder and dispensing device, comprising:
i) a programmable docking unit comprising at least one chamber for storing bulk medication and a base including a slot for dispensing a medication on-demand;
ii) a programmable personal medicine container insertable through the slot for receiving a predetermined supply of the medication and for downloading a medication regimen from the docking unit;
iii) the personal medicine container including a medication holding section and a display section; and
iv) the personal medicine container including an alarm for reminding a person to take or administer the medicine in accordance with the medication regimen;
c) downloading the medication regimen into the docking unit;
d) obtaining the predetermined supply of the medication into the personal medicine container from the docking unit; and
e) taking or administering the medicine from the personal medicine container when prompted by the alarm.

22. The method of claim 21, wherein:
step d) comprises obtaining daily or weekly supply of the medication.

23. The method of claim 21, wherein:
step c) comprises downloading the medication regimen from a desk-top computer, a portable computer, a hand-held electronic device, a wireless device, a network, an intranet, or the Internet.

24. The method of claim 21, wherein:
step a) includes modifying or renewing an existing medication regimen.

25. A medication reminder and dispensing method, comprising the steps of:
a) providing a medication regimen;
b) providing a personal medication reminder and dispensing device, comprising:
i) a programmable docking unit comprising a plurality of chambers for storing bulk medication and a base including a slot for dispensing one or more medications on-demand;
ii) a programmable personal medicine container insertable through the slot receiving a predetermined supply of the medication and for downloading a medication regimen from the docking unit;
iii) the personal medicine container including a medication holding section and a display section;
iv) the holding section including a plurality of pockets corresponding in number to the chambers;
v) a movable cover for providing access to the pockets; and
vi) the personal medicine container including an alarm for reminding a person to take or administer the medicine in accordance with the medication regimen;
c) downloading the medication regimen into the docking unit;
d) obtaining the predetermined supply of the medication into the personal medicine container from the docking unit; and
e) taking or administering the medicine from the personal medicine container when prompted by the alarm.

26. The method of claim 25, wherein:
step d) comprises obtaining daily or weekly supply of the medication.

27. The method of claim 21, wherein:
step c) comprises downloading the medication regimen from a desk-top computer, a portable computer, a hand-held electronic device, a wireless device, a network, an intranet, or the Internet.

28. The method of claim 25, wherein:
step a) includes modifying or renewing an existing medication regimen.
